(19) United States
(12) Patent Application Publication
(10) Pub. No.: US 2006/0155980 A1
(43) Pub. Date: Jul. 13, 2006

(54) Method and system for reacting to a change of a upnp device

(75) Inventor: Maarten Peter Bodlaender, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/545,182

(22) PCT Filed: Jan. 28, 2004
(86) PCT No.: PCT/IB04/50058

§ 371 Date: Aug. 9, 2005

(30) Foreign Application Priority Data
Feb. 12, 2003 (EP) 03100299.1

(51) Int. Cl. G06F 1/24

(52) U.S. Cl. 713/100

(57) ABSTRACT

The invention relates to a method of reacting, by a UPnP control point (302), to an upcoming change of a configuration of a UPnP device (304), the method comprising: offering a migration service, by the UPnP device, to the UPnP control point (302); subscribing to the migration service by the UPnP control point (302); notifying the UPnP 5 control point (302) through a change event of the upcoming change of the configuration of the UPnP device (304); changing the configuratioin of the UPnP device (304); reacting, by the UPnP control point (302), to the change of the configuration of the UPnP device (304) based upon the change event. The invention further relates to a system (300, 328, 330) for reacting, by a UPnP control point (302), to an upcoming change of a configuration of a UpnP device (304), the system (300, 328, 330) comprising: offering means (312) conceived to offer a migration service, by the UPnP device (304), to the UPnP control point (302); subscribing means (322) conceived to subscribe to the migration service by the UPnP control point (302); notifying means (314) conceived to notify the UPnP control point (302) through a change event of the upcoming change of the configuration of the UPnP device (304); changing means (316) conceived to change the configuration of the UPnP device (304); reacting means (324) conceived to react, by the UPnP control point (302), to the change of the configuration of the UPnP device (304) based upon the change event.

The invention relates to a method of reacting, by a UPnP control point, to an upcoming change of a configuration of a UPnP device.

The invention further relates to a system for reacting, by a UPnP control point, to an upcoming change of a configuration of a UPnP device.

The invention further relates to a computer readable medium having stored thereon instructions for causing one or more processing units to perform such a method.

The invention further relates to a UPnP device and a UPnP control point comprising such a system.

“Universal Plug and Play (UPnP) is an architecture for pervasive peer-to-peer network connectivity of intelligent appliances, wireless devices, and PCs of all form factors. It is designed to bring easy-to-use, flexible, standards-based connectivity to ad-hoc or unmanaged networks whether in the home, in a small business, public spaces, or attached to the Internet. Universal Plug and Play is a distributed, open networking architecture that leverages TCP/IP and the Web technologies to enable seamless proximity networking in addition to control and data transfer among networked devices in the home, office, and public spaces as in “Universal Plug and Play Device Architecture”, Version 1.0, 8 Jun. 2000, © 1999-2000 Microsoft Corporation, of which a next version, Version 2.0 is currently under development.

An embodiment of such a method and system is disclosed in WO 02/49276. Here, a network of UPnP control point devices and controlled devices is described. Each device provides the network with a few essential specifics about the device and/or its services. The control point devices can search for devices of particular interest. Devices are logged off the network when they communicate a logoff message. When a control point learns of a device's capabilities, it is able to control and/or monitor the device. The control point can also request notification whenever an event occurs at the device. The Control Point ‘subscribes’ to be notified of any change of state at the device, and may exclude specified state changes, such as the change of value of particular variables, from this notification process. Whenever a device changes state, it notifies all subscribers of the event, except those subscribers that have excluded the specific state change from their subscription. When a device changes because of for example a change in IP address and/or the need to change any part of the device description, the device needs to log off the network. It must send a “byebye” message, effectively stating that its embedded devices and services are no longer available. After the device has logged off the network, it can re-establish a connection with the network and re-announce its, possibly changed, specifics and services.

It is a further object of the invention to provide a method as set forth above that improves the communication between a UPnP device and a UPnP control point. To achieve this object, the method comprises:
offering a migration service, by the UPnP device, to the UPnP control point;
subscribing to the migration service by the UPnP control point;
notifying the UPnP control point through a change event of the upcoming change of the configuration of the UPnP device;
changing the UPnP device;
reacting, by the UPnP control point, to the change of the configuration of the UPnP device based upon the change event.

By offering the migration service to which a UPnP control point can subscribe, the UPnP control point can be notified that the UPnP device will change by logging off from the network. The UPnP control point can then take precaution measures to minimize the effects of the, possibly, temporal unavailability of the UPnP device.

An embodiment of the method according to the invention is described in claim 2. By notifying the UPnP control point of the new IP-address of the UPnP device, the UPnP device can take precaution measures for possible effects of the changed IP-address. For example, when the UPnP control point contains a Universal Resource Locator (URL) to the UPnP device, the URL can be changed before the UPnP device re-announces itself to the network. Furthermore, an eventual cache maintained by the UPnP control point, containing the “old” URL's, can be cleared.

An embodiment of the method according to the invention is described in claim 3. By notifying the UPnP control point of a changed service of the UPnP device, the UPnP device can take precaution measures for possible effects of the changed service. The service can for example be dropped, thereby enabling the UPnP device for example to remove the access to the service from its user interface. This prevents that, for example a user tries to access the service while the service is not available anymore on the network.

It is an object of the invention to provide a system as set forth above that improves the communication between a UPnP device and a UPnP control point. To achieve this object, the system comprises:
offering means conceived to offer a migration service, by the UPnP device, to the UPnP control point;
subscribing means conceived to subscribe to the migration service by the UPnP control point;
notifying means conceived to notify the UPnP control point through a change event of the upcoming change of the configuration of the UPnP device;
changing means conceived to change the UPnP device;
reacting means conceived to react, by the UPnP control point, to the change of the configuration of the UPnP device based upon the change event.

Embodiments of the system according to the invention are described in the dependent claims.

These and other aspects of the invention will be apparent from and elucidated with reference to the embodiments described hereinafter as illustrated by the following figures.

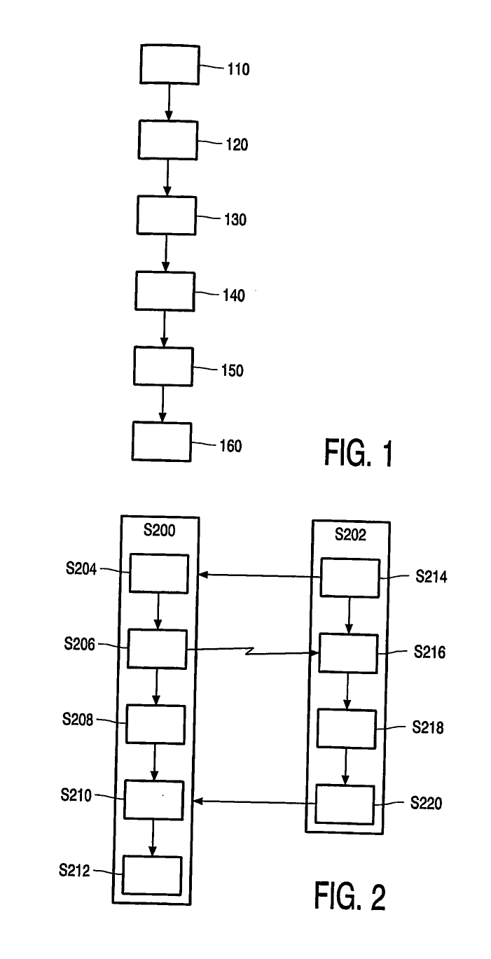

FIG. 1 illustrates an example UPnP process for establishing and maintaining a network of UPnP Control Point devices and Controlled devices;

FIG. 2 illustrates an example of the method according to the invention in a schematic way;

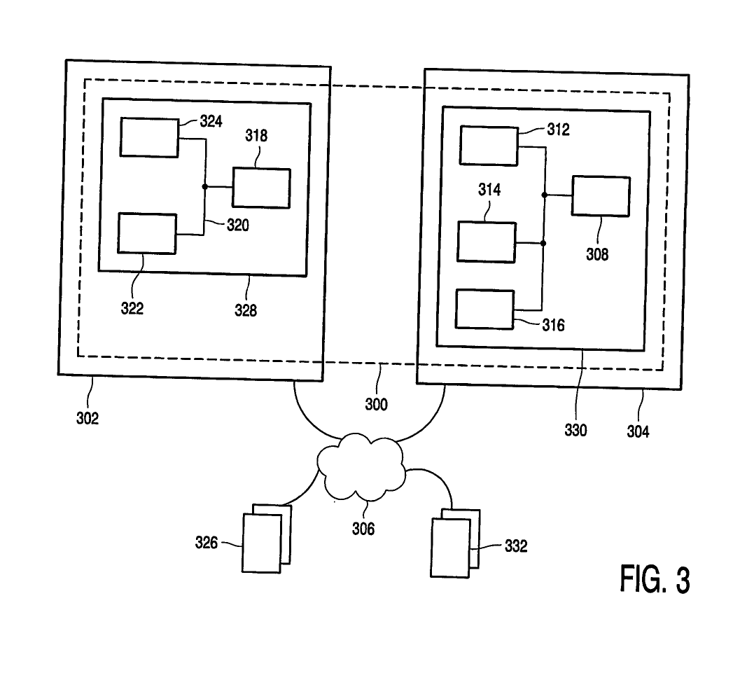

FIG. 3 illustrates an example of the system according to the invention in a schematic way.

FIG. 1 illustrates an example UPnP process for establishing and maintaining a network of UPnP Control Point devices and Controlled devices. The foundation for UPnP networking is IP addressing. Each device is assigned a unique address, at 110, either via an assignment by a Dynamic Host Configuration Protocol (DHCP) server that is managing the network, or via an Auto IP address generation function, if the network is not managed. Devices may also be assigned a UPnP friendly device name, for ease of subsequent references to each device. However, an other name, like the Dynamic Naming Service (DNS) name could also be used when applicable.

Given an IP address, the next step in the UPnP process is discovery 120, wherein each device provides the network with a few essential specifics about the device or its services, with a pointer to more detailed information, as required. The Control Points also use the discovery process to search for devices of particular interest. The devices advertise their essential characteristics when they first enter the network, as well as in response to a search for their characteristics by a Control Point. To assure that the network is kept up to date, devices are required to periodically refresh their advertisement via the discovery process 120. Devices are logged off the network when they communicate a logoff message, or when they fail to refresh their advertisement.

The next step in the UPnP process is description 130, wherein Control Points that are interested in advertised devices issue a request for additional information from a URL (Universal Resource Locator) address that is contained in the device advertisement. Typically, this additional information regarding the device and its services is located at the device, but it may also be located at a remote location, such as an Internet site that is maintained by the vendor of the device.

When a Control Point learns of a device's capabilities, it is able to control and/or monitor the device, at 140, via an action request or a value query. In response to the action request, the device effects the action, and reports a result. Generally, the result is an acknowledgement that the requested action was effected, but it may be a more detailed message that reports the current device state, and/or the state of one or more variables associated with the device. In response to a value query, the device reports the state of one or more variables identified in the value query.

The Control Point may also request notification whenever an event occurs at the device, via the eventing process 150. The Control Point ‘subscribes’ to be notified of any change of state at the device, and may exclude specified state changes, such as the change of value of particular variables, from this notification process. Whenever a device changes state, it notifies all subscribers of the event, except those subscribers that have excluded the specific state change from their subscription.

The Control Point presents the capabilities and controls associated with a device, based on a presentation page that is provided by the device, at 160. The Control Point requests the presentation page from a URL that is provided in the device description. As with the device description at 130, the URL may address the device, or it may address a remote site, such as the vendor's Internet site, or a third-party service provider's site.

Now if a controlled device logs off the network because for example the device needs to reboot, the control point will determine that the controlled device leaves the network. In the case the controlled device is present within the user interface of the control point, the controlled device can remove the controlled device from its user interface. If the controlled device enters the network again, the controlled device can be added again to the user interface. When the time in between leaving and entering the network is very short this causes flickering artifacts in the user interface. For example, a media renderer (controlled device) that temporarily leaves the network because its IP address changes, will be removed completely, while it is only down for such a short time that this downtime may be neglected in the user interface.

FIG. 2 illustrates an example of the method according to the invention in a schematic way. Here, S200 denotes the steps of the method for a UPnP controlled device and S202 denotes the steps of the method for a UPnP control point Within the announce step S120, the controlled device announces its migration service. The generic announcement message of services includes the following parameters as defined by the UPnP 1.0 device architecture specification on http://www.upnp.org/download/UPnPDA10_{—}20000613.htm (italics is placeholder for actual values):

NOTIFY*HTTP/1.1

HOST: 239.255.255.250:1900

CACHE-CONTROL: max-age=seconds until advertisement expires

LOCATION: URL for UPnP description for migration service

NT: search target

NTS: ssdp:alive

SERVER: OS/version UPnP/1.0 product/version

USN: advertisement UUID

wherein:

“HOST” Required. Multicast channel and port reserved for Simple Service Discovery Protocol (SSDP) by Internet Assigned Numbers Authority (IANA). Must be 239.255.255.250:1900.

“CACHE CONTROL” Required. Must have max-age directive that specifies number of seconds the advertisement is valid. After this duration, control points should assume the device (or service) is no longer available. Should be >1800 seconds (30 minutes). Specified by UPnP vendor. Integer.

“LOCATION” Required. Contains a Uniform Resource Locator (URL) to the UPnP description of the root device. In some unmanaged networks, host of this URL may contain an IP address (versus a domain name). Specified by UPnP vendor. Single URL.

“NT” Required header defined by GENA. Notification Type. Must be one of the following. Single Uniform Resource Identifier (URI).

“upnp:rootdevice” Sent once for root device.

“uuid:device-UUID” Sent once for each device, root or embedded. Device UUID specified by UPnP vendor.

“urn:schemas-upnp-org:device:deviceType:v”
Sent once for each device, root or embedded. Device type and version defined by UPnP Forum working committee.

“urn:schemas-upnp-org:service:serviceType:v”
Sent once for each service. Service type and version defined by UPnP Forum working committee.
   “NTS” Required header defined by General Event Notification Architecture (GENA). Notification Sub Type. Must be “ssdp:alive”. Single URI.
   “SERVER” Required. Concatenation of Operating System (OS) name, OS version, UPnP/1.0, product name, and product version. Specified by UPnP vendor. String.
   “USN” Required header defined by SSDP. Unique Service Name. Must be one of the following. The prefix (before the double colon) must match the value of the Unique Device Name (UDN) element in the device description. Single URI.

“uuid:device-UUID::upnp:rootdevice”
Sent once for root device. Device Universal Unique Identifier (UUID) specified by UPnP vendor.

“uuid:device-UUID” Sent once for every device, root or embedded. Device UUID specified by UPnP vendor.

“uuid:device-UUID::urn:schemas-upnp-org:device:deviceType:v”
Sent once for every device, root or embedded. Device UUID specified by UPnP vendor. Device type and version defined by UPnP Forum working committee.

“uuid:device-UUID::urn:schemas-upnp-org:service:serviceType:v”
Sent once for every service. Device UUID specified by UPnP vendor. Service type and version defined by UPnP Forum working committee.
   for example a non-standardized Migration Service (actual values filled in):
   NOTIFY*HTTP/1.1
   HOST: 239.255.255.250:1900
   CACHE-CONTROL: max-age=300
   LOCATION: http://169.254.25.129:80/public/description.xml
   NTS: ssdp:alive
   SERVER: Win/5.0, UPnP/1.0, Philips UPnP-Stack/1.0
   NT: urn:Philips:service:Migration:1
   USN: uuid:PhilipsTestDevice::urn:Philips:service:Migration:1
   (if standardized, USN & NT replace “urn:Philips:” by “urn:schemas-upnp-org”) Basically, the value of the NT and USN headers indicate the presence of a Migration service in the device, identified in the USN header and the description location at “LOCATION” to Control Points. Control Points that know the Migration service can now proceed to retrieve the description document of the service, from where they can retrieve the URL they need to use to subscribe to events.

In the case that the controlled device needs to log off from the network because for example, it's IP address changes, a service must be stopped, a service must be added, etc., then, within step S206, the controlled device notifies the subscribers of the forthcoming log off. To this end, the following state variables are defined in the Migration service:

1) target IP address.

2) list of target services

The list of target services is a comma-separated list of “service type:service version”. Examples of “service type” are: content directory service and audio video transport connection manager.

The notified migration event comprises those state variables that changed, thus: the new IP address, and/or the list of target services. Within a next step S208 the controlled device logs off the network using the appropriate UPnP protocol. Then, after changing its services, the controlled device “reboots” within step S210. With this reboot, the controlled device stops all its services, unsubscribes to all it subscriptions and performs all other steps that are required by the UPnP protocol. Then, it re-announces itself to the network within step S212 as previously described within step S120.

Within the previously described eventing step S150, the UPnP control point subscribes to the migration service of the controlled device within step S214. Within step S216, the control point receives the migration event, which was sent by the controlled device.

Within the next step, S218, the controlled device takes precaution measures in reaction to the received migration event. For example, the control point can use a caching mechanism as a precaution measure for accessing a service during the down-time of the service. Using this caching mechanism the user interface of the control point can continue offering the service during the down-time, if a controlled device announces that it will drop its service temporarily and it will come up again. If a request is made for the service during the down-time, the control device can cache this request and sent it to the controlled device after the controlled device has re-announced itself to the network.

Also, “out-of-band” streams can be set-up using the UPnP AudioVideo (AV) framework (See the UPnP AV architecture 0.83 document on http://www.upnp.org/download/UPnPAvArchitecture%200.83.prtad.pdf. The UPnP Audio Video 1.0 standard (see http://www.intel.com/technology/itj/2002/volume06issue04/art02_distribution/p09_reference s.htm) specifies how Control Points can set up out-of-band streams between MediaServer and MediaRenderer implementations. A typical out-of-band streaming mechanism like HTTP-GET, streams the data over an IP network using a Transmission Control Protocol (TCP) connection. Since the definition of a TCP connection contains both the IP address of the source and the target of the stream, a change of IP address destroys this connection. This could lead to interrupts in the presentation of audio/video content, which a user would perceive as low quality.

TCP migration (see http://nms.lcs.mit.edu/projects/migrate or http://discolab.rutgers.edu/mtcp/) is a known mechanism for keeping a TCP connection intact, while changing the IP address of one of the end-points of the connection. One of the problems with TCP migration is that both sides have to support this and have to agree on initiating the migration. The UPnP Migration service can provide the necessary control information to this (out-of-band) protocol, to perform the migration. It should be noted that such TCP migration is only required for streaming protocols over TCP. Out-of-band streaming protocols that do not rely on IP addresses (for example 1394/IEC61883 streaming) are unaffected by changed IP addresses.

Examples of Control Points, MediaRenderers and MediaServers are:
Philips iPronto: portable touch-screen with 802.11b connection to network, allows control of all UPnP devices on network
Philips Streamium. Mainly a MediaRenderer: a Control Point can tell it to play content, by giving it the right URL. However, it is also a MediaServer: by inserting an MP3 CD into the Streamium, it presents these contents to the network. It is also a Control Point: it can control other Streamiums on the network.

In the case that the migration event contains a new IP address for the controlled device, the control point can update all its references to the old IP address as a precaution measure. If only the IP address is changed, an application or user interface using the controlled device may not be notified of the migration. For example if an application is browsing a media server, it will continue browsing the media server using the new IP address.

A TCP connection is defined by 4 parameters:
1,2 IP address and Portnumber of initiator of connection,
3,4 IP address and Portnumber of target of connection
   These parameters are present in each message sent. If now initiator or target changes IP address, the messages no longer arrive, and the connection is broken.

Assume that the target changes IP address (symmetrical solution for initiator) TCP migration is a mechanism (present in an old version of Linux) that allows two things:

1) both initiator and target agree on trying to keep the TCP connection open

2) the initiator can discover the new IP address/Portnumber for the old connection

With these two facts, both target and initiator replace the IP address and Portnumber of the target in their current TCP connection. Messages that were in transit during the connection will be lost (and thus never acknowledged, and thus retransmitted as normal TCP behavior). New messages will be sent with the new definition.

In the case that the migration event contains a dropped service, the user interface can be updated such that the dropped service is not available anymore. In the case that the migration event contains a new service, the application can anticipate upon this new service. For example if an additional image enhancement function becomes available, the application can suspend processing the current images until the enhancement function becomes available. Because of the migration event, the subscribed control point “knows” that the controlled device is going to re-boot.

Within the next step, S220 the controlled device re-announces itself to the network and all control points can re-subscribe to services offered by the controlled device. This ensures compatibility with Control Points that do not support the Migration Service.

The order of the described method steps is a preferred order of performing the method according to the invention. However, other orders of performing the steps are also conceivable. It is also conceivable that some steps are not performed without departing from the concept of the invention.

FIG. 3 illustrates an example of the system according to the invention in a schematic way. The system 300 is divided into two sub-systems 328 and 330: one sub-system 328 residing within the UPnP control point 302 and one subsystem 330 residing within the UPnP controlled device 308. The UPnP control point 302 is a MP3 playing device and the UPnP controlled device 308 is an MP3 server. The MP3 playing device 302 is connected to the MP3 server through network 306. To the network more control points 326 and more controlled devices 332 are connected. More than one control point can control the controlled devices.

The sub-system 328 comprises one or more microprocessors 318 and general-purpose memories 322 and 324. Instead of two memories, also one memory can be used. The memories 322 and 324 communicate with the microprocessor 318 through software bus 320. The memory 322 comprises computer readable code designed to perform subscribing to a migration service as previously described. The memory 324 comprises computer readable code designed to perform reacting to a received migration event. The system further comprises memory that comprises computer readable code designed to perform the UPnP protocol for a UPnP control point as described by the UPnP protocol specification.

The sub-system 330 comprises one or more microprocessors 308 and general-purpose memories 312, 314, and 316. Instead of these memories, also one memory can be used. The memories 312, 314, and 316 communicate with the microprocessor 308 through software bus 310. The memory 312 comprises computer readable code designed to perform advertising as previously described. The memory 314 comprises computer readable code designed to perform notify a migration event as previously described. The memory 316 comprises computer readable code designed to perform changing the IP address or available services as previously described. The system further comprises memory that contains computer readable code designed to perform the UPnP protocol as described by the UPnP protocol specification.

Within an other embodiment of an Audio Video framework, the system is divided into three sub-systems: a control point, for example a remote control like the Philips iPronto; a MediaServer like a PC with a hard-disk comprising MP3 files; and a MediaRenderer like the Philips Streamium. It is also conceivable that the different sub-systems are combined into one physical system.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer. In the system claims enumerating several means, several of these means can be embodied by one and the same item of computer readable software or hardware. The mere fact that certain measures are recited in mutually different dependent claims does not indicate that a combination of these measures cannot be used to advantage.

1. Method of reacting, by a UPnP control point (302), to an upcoming change of a configuration of a UPnP device (304), the method comprising:
offering a migration service, by the UPnP device, to the UPnP control point (302);
subscribing to the migration service by the UPnP control point (302);
notifying the UPnP control point (302) through a change event of the upcoming change of the configuration of the UPnP device (304);
changing the configuratioin of the UPnP device (304);
reacting, by the UPnP control point (302), to the change of the configuration of the UPnP device (304) based upon the change event.

2. Method according to claim 1, wherein the change event comprises a new IP address for the UPnP device (304).

3. Method according to claim 1, wherein the change event comprises a change of a service provided by the UPnP device (304).

4. System (300, 328, 330) for reacting, by a UPnP control point (302), to an upcoming change of a configuration of a UPnP device (304), the system (300, 328, 330) comprising:
offering means (312) conceived to offer a migration service, by the UPnP device (304), to the UPnP control point (302);
subscribing means (322) conceived to subscribe to the migration service by the UPnP control point (302);
notifying means (314) conceived to notify the UPnP control point (302) through a change event of the upcoming change of the configuration of the UPnP device (304);
changing means (316) conceived to change the configuration of the UPnP device (304);
reacting means (324) conceived to react, by the UPnP control point (302), to the change of the configuration of the UPnP device (304) based upon the change event.

5. A computer readable medium having stored thereon instructions for causing one or more processing units to perform the method according to claim 1.

6. A UPnP device (304) comprising the system according to claim 4.

7. UPnP control point (302) comprising the system according to claim 4.
